(19) United States
(12) Patent Application Publication
(10) Pub. No.: US 2001/0056407 A1
(43) Pub. Date: Dec. 27, 2001

(54) System and method of displaying public notices via a digital network

(76) Inventor: Eddie H. Williams, Fountain Hills, AZ (US)

Correspondence Address: Brett A. Carlson, Snell & Wilmer L.L.P., One Arizona Center, 400 East Van Buren, Phoenix, AZ, 85004-2202, US

(21) Appl. No.: 09/879,763

(22) Filed: Jun. 12, 2001

Related U.S. Application Data
(60) Provisional application No. 60/212,227, filed on Jun. 16, 2000.

(51) Int. Cl. G06F 17/60

(52) U.S. Cl. 705/52; 705/14; 707/104.1

(57) ABSTRACT

According to various embodiments of the present invention, a method of displaying a notice to a viewer includes the steps of receiving the notice at a server, formatting the notice in a display format, displaying the notice on the server, receiving a request from a viewer to view the notice, and providing the notice from the server to the viewer in response to the user's request. According to other exemplary embodiments, a system for displaying a notice to a viewer via a digital network includes a database configured to retain the notice, an interface to the digital network, and a server application configured to provide documents to the viewer via the interface, wherein the server application is configured to retrieve the notice from the database and to provide the notice to the user via the interface in response to requests for the notice received from the user via the interface.

This application claims priority of PROVISIONAL APPLICATION SERIAL No. 60/212.227 filed on Jun. 16, 2001.

### FIELD OF THE INVENTION

The invention relates generally to systems and methods for displaying public notices. More particularly, the invention relates to systems and methods for displaying notices, community information and the like via a digital network such as the Internet.

### BACKGROUND OF THE INVENTION

Public notices such as notices of foreclosure, notices of public sale, notices relating to class action law suits, legal notices and the like are frequently required by law to be published or otherwise made available to the public. Such notices are frequently published in a newspaper, magazine, gazette, journal or the like which may be made available to the public. Various newspapers, for example, have carried legal and other public notices for many years.

Newspapers, journals, magazines and the like typically exhibit a number of marked disadvantages, however. First, newspapers are typically made of paper and therefore require physical resources (trees, dyes, and the like) that may be scarce, expensive and/or environmentally unsound. Moreover, paper journals are characterized by numerous disadvantages relating to distribution and information retrieval. For a member of the public to gain access to a particular notice, for example, he or she must purchase the journal (which may or may not be readily available in that person's area) and then manually scan the pubic notices section for public notices of interest. Because many journals routinely publish dozens, hundreds or even thousands of public notices over relatively short periods of time, it can be extremely difficult for relevant members of the public to locate and read those notices that may affect them. It is therefore desired to create a system capable of presenting public notices in an easy-to read manner that is widely available to the public.

### BRIEF DESCRIPTION OF THE DRAWING FIGURES

According to various embodiments of the present invention, a method of displaying a notice to a viewer includes the steps of receiving the notice at a server, formatting the notice in a display format, displaying the notice on the server, receiving a request from a viewer to view the notice, and providing the notice from the server to the viewer in response to the user's request. According to other exemplary embodiments, a system for displaying a notice to a viewer via a digital network includes a database configured to retain the notice, an interface to the digital network, and a server application configured to provide documents to the viewer via the interface, wherein the server application is configured to retrieve the notice from the database and to provide the notice to the user via the interface in response to requests for the notice received from the user via the interface.

### BRIEF DESCRIPTION OF THE DRAWING FIGURES

The above and other features and advantages of the present invention are hereinafter described in the following detailed description of illustrative embodiments to be read in conjunction with the accompanying drawing figures, wherein like reference numerals are used to identify the same or similar parts in the similar views, and:

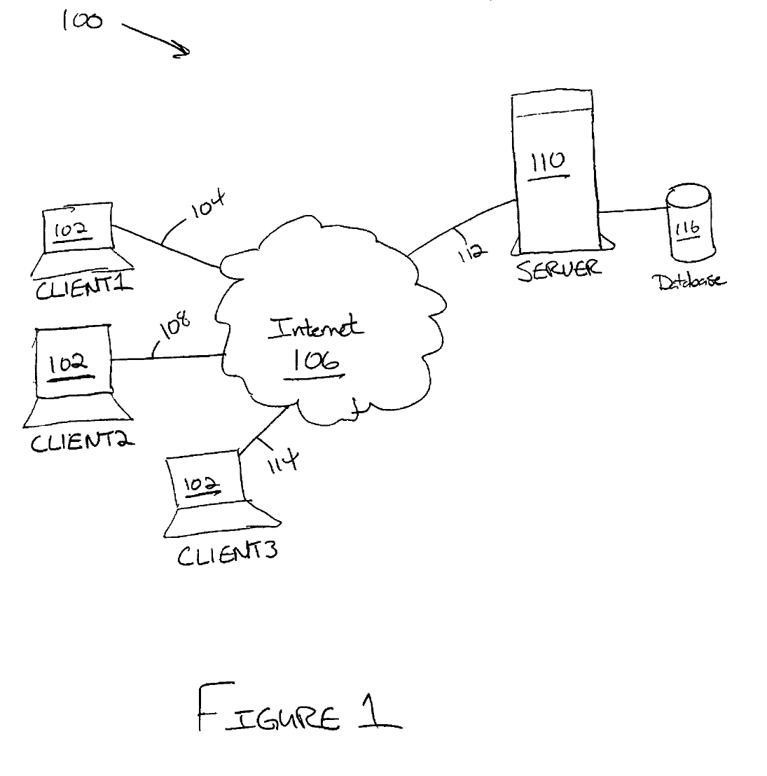

FIG. 1 is a block diagram of an exemplary public announcement system;

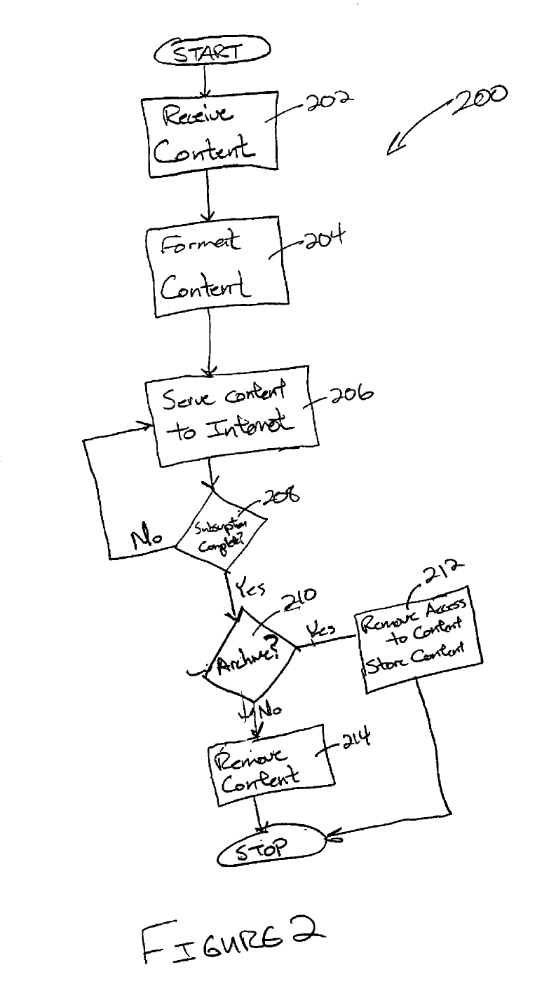

FIG. 2 is a flow chart of an exemplary process for publishing public notices; and

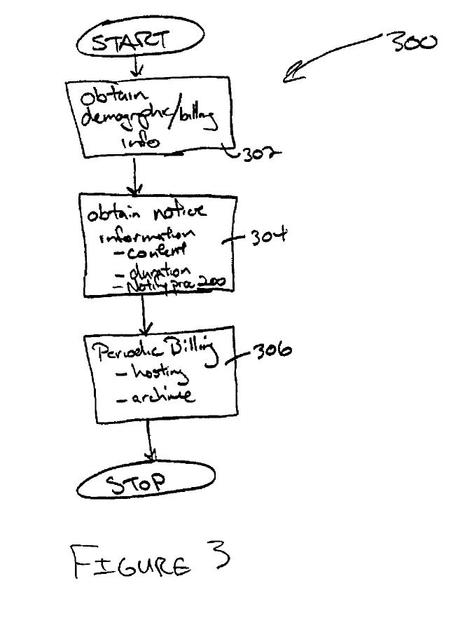

FIG. 3 is a flow chart of an exemplary process for handling subscribers to a public notice system.

### DETAILED DESCRIPTION OF EXEMPLARY EMBODIMENTS

The present invention may be described herein in terms of functional block components and various processing steps. It should be appreciated that such functional blocks may be realized by any number of hardware and/or software components configured to perform the specified functions. For example, the software elements described herein be implemented with any programming or scripting language such as C, C++, PASCAL, Java, assembler, PERL, PHP, any database programming language or the like, and the various algorithms may be implemented with any combination of data structures, objects, processes, routines or other programming elements. Similarly, the invention could be used in conjunction with any type of personal computer, network computer, workstation, minicomputer, mainframe, or other computer running any version of Windows, MacOS, BeOS, Linux, UNIX, Solaris or any other operating system. Further, the present invention might employ any number of conventional techniques for data transmission, signaling, data processing, network control, and the like. For example, radio frequency (RF) or other wireless techniques could be used in place of any network technique described herein. Moreover, although the invention is frequently described herein as being implemented with TCP/IP communications protocols, it will be readily understood that the invention could also be implemented using IPX, Appletalk, IP3, IP-6, NetBIOS, OSI or any number of existing or future protocols. Further, the term “Internet” may refer to the Internet, any replacement, competitor or successor to the Internet, or any public or private internetwork, intranet or extranet that is based upon open or proprietary protocols. Specific information related to the protocols, standards, and application software utilized by in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference. Additionally, the term “web page” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

The particular implementations shown and described herein are illustrative of the invention and are not intended to limit the scope of the invention in any way. Indeed, for the sake of brevity, conventional data networking, application development and other is functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical public notice system. To simplify the description of the exemplary embodiments, the invention is frequently described as pertaining to a system of providing access to legal notices. It will be appreciated, however, that many applications of the present invention could be formulated. For example, the present invention could be used to promote or distribute any type of public information such as legal notices, public announcements, notices of performances, notices of auctions or public sales, or the like.

FIG. 1 is a block diagram of an exemplary public notice system 100. With reference to FIG. 1, a number of client systems 102 communicate with a server system 110 via a network 106 to send and/or receive public notices. Server 110 suitably maintains public notice information in a database 116 and retrieves public notice information as requested by client systems 102.

User systems 102 may include any convenient combination of hardware and software components configured to allow a user to communicate with over network 106. For example, user system 102 might include a standard personal computer (PC) comprising a CPU, monitor, storage, keyboard, mouse, and communication hardware appropriate for the given data link 104 (e.g., V.90 modem, network card, cable modem, etc.). User system 102 might also include one or more peripheral devices such as a scanner, a digital camera, a motion video camera, a TV Tuner card, or the like. In alternate embodiments, user system 102 is a personal data assistant (PDA) capable of manipulating images and communicating with server 110. In yet another embodiment, user system 102 is a kiosk located at a mall, theme park, post office, street, airport, or any other location.

User systems 102 typically include an operating system (e.g., Windows 95/98/2000, Linux, Solaris, MacOS, etc.) as well as various conventional support software modules and drivers typically associated with computers. User system 102 may also include application software configured to communicate over network 106 with server 110, for example, a world wide web (WWW) browser or any other communication software. In an exemplary embodiment, user system 102 includes a conventional Internet browser application that operates in accordance with HTML and HTTP protocols such as Netscape Navigator (available from the Netscape Corporation of Mountain View, Calif.) or Microsoft Internet Explorer (available from the Microsoft Corporation of Redmond, Wash.).

Client systems 102 and server 110 are suitably coupled to network 106 via data links 104, 108, 114 and 112, respectively. A variety of conventional communications media and protocols may be used for data links 104, 108, 112 and 114. Such links might include, for example, a connection to an Internet Service Provider (ISP) over the local loop as is typically used in connection with standard modem communication, cable modem, Dish networks, ISDN, Digital Subscriber Line (DSL), or various wireless communication methods. User system 102 might also reside within a local area network (LAN) which interfaces to network 106 via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

Server 110 comprises any number of hardware, software, and networking components necessary to provide a suitable website or other network-based graphical user interface that is accessible by users, and which provides the functionality described in further detail below. In one embodiment, Sun Ultra SPARC Enterprise 250 and 450 servers are used in conjunction with a Sun Solaris 7 or Linux operating system, Apache web server software, and an Oracle 8 or MySQL database system. Of course particular hardware and software components used in server 110 will vary widely from embodiment to embodiment. Furthermore, server 110 may represent a “cluster” or group of separate computer systems providing the functionalities described herein.

Server 110 suitably maintains public notice information in a database 116. Database 116 may be a graphical, hierarchical, relational, object-oriented or other database, and may be maintained on a local drive of server 110 or on a separate computer coupled to server 110 via a local area or other network (not shown). In one embodiment, database 116 is a collection of ASCII or other text files stored on a local drive of server 110. Content is suitably retrieved from database 116 and provided to user systems 102 upon request via a server application, as described more fully below. In one embodiment, content stored in “flat” ASCII files on database 116 is retrieved from the database, formatted into a suitable format such as hypertext markup language (HTML), XML or the like, and provided to client 102 by an appropriate web server application. Content data may be transferred from raw text, scanned text or another source into a desired format through the use of an HTML editor or similar tool, or through any other technique.

FIG. 2 is an exemplary technique for providing public notice information via a network 106. With reference now to FIG. 2, public notice content (also referred to herein as simply “content”) is received at server 110 through any technique and stored in database 116 (step 202). In one embodiment, content may be manually entered via a keyboard, scanner, mouse or other device attached to server 110. Alternatively, content may be entered at a client system 102 and provided to server 110 via network 106, for example using the file transfer protocol (FTP) or another data transfer technique. In one embodiment, users enter content to a window provided by server 100 as part of a subscription process 300, as described below. Content is suitably formatted into HTML or another display format (step 204), and provided to the public via network 106 as appropriate (step 206). Formatting may be performed manually by an administrator using any conversion utility, HTML editor, or the like. Alternatively, formatting may take place automatically on server 110 by a process that receives text, ASCII or other data and automatically converts the content to HTML or another display format. In other embodiments, formatting step 204 is accomplished by users or publishers prior to submittal such that content is received in HTML format. Alternatively, formatting step 204 may not be required in all embodiments.

Public notices may be provided on network 106 for any time period specified by a user (as described below) or an administrator. In various embodiments, content is provided for a “subscription period” which may correspond to a day, a week, a month, a year, or any other period of time. After the subscription period has elapsed (step 208), content may be removed or deleted, or content may remain on server 110 but access to the public may be disabled. In an exemplary embodiment, pages corresponding to various public notices will be assigned unique file names to which access rights may be granted or denied in the web server application. In other embodiments, pages may be moved between directories having varying access characteristics as appropriate. For example, server 110 may have a first directory of files that are published on network 106 and a second directory of files that are stored on server 110 (or in database 116) but not made available to the public on network 106. Access privileges to the files may then be modified by manually or automatically moving files between the first and second directory.

In various embodiments, files are stored on server 110 or in database 116 during and/or after display to create an archive. If archiving is requested (step 210), content may be removed from the publicly accessible portion of server 110 and stored in a separate directory, region or file (step 212). Alternatively, a hardcopy of the notice may be printed and retained separate from server 110. Archiving services may be used to meet legal “retention of notice” requirements, or for any other purpose. If content is not be archived, it may be deleted or otherwise removed from public access (step 214) as appropriate.

FIG. 3 is a flow chart of an exemplary subscription process suitable for use with the public display system 100 described herein. With reference now to FIG. 3, a user (“subscriber”) connects to server 110 via network 106 and may receive a “login” screen that prompts the user for a userid/password combination, or some other credential. In alternate embodiments, a “cookie” or similar data identifier may be stored on user system 102 such that authentication takes place without manual actions by the user.

If a user is not yet a subscriber to the service, a “new user” screen may be made available (step 302). The “new user” screen provides a form for the user to provide information, and may incorporate “secure HTML”, the secure sockets layer (SSL) protocol, public/private key cryptography, or the like to protect information travelling across network 106. In various embodiments, the “new user” screen prompts for a user's name, contact information, billing information (including a credit card number, for example) and/or any other information that may be appropriate. Demographic information (gender, income, ZIP code, etc.) may also be obtained in various embodiments. The new user process may also include a check of a credit card or other payment credential to ensure that the new user is authorized to perform financial transactions with the credential.

After successfully providing an authorization credential, approved users are granted access to server 110. Users may be prompted to provide new public notices (step 304), for example. Server 110 may provide a form to the user system 102 so that the user may enter notice content, a desired display period, and other relevant information (e.g. keywords, description of the notice, etc.). After the notice is received, subscription process 300 may notify display process 200 of a new notice that is to be provided on network 106, and the user may be billed accordingly.

The various users of system 100 may be billed on a periodic basis, on a “per hit” basis, or according to any other scheme. In an exemplary embodiment, users are billed in monthly increments according to a flat fee for each notice or announcement. Alternatively, fees may be based upon the size of the announcement, location on a page with respect to other announcements that may share the same page, or according to any other criteria. Billing may be accomplished by a billing process on server 110, or by an external accounts receivable or billing program. Alternatively, billing may be handled manually by an administrator.

It will be understood that once public notices are made available on network 110 via server 106, computer users around the world may access and read the notices. Notices may each encompass their own separate page or HTML documents, or multiple notices may be combined into one or more HTML documents. Browsing may be made available at no charge (or for a fee), and users may search for particular keywords (such as their name, a property address, or the like) using a search engine incorporated within server 110 or using search capabilities incorporated within conventional browser programs. Pages are provided from server 110 to user systems 102 as requested by the particular users, who may then search, browse, read or otherwise digest the contents of the notice.

The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above.

What is claimed is:

1. A method of displaying a notice to a viewer, the method comprising the steps of:
receiving said notice at a server;
formatting said notice in a display format;
displaying said notice on said server;
receiving a request at said server from said viewer to view said notice; and
providing said notice to said viewer in response to said request.

2. A system for implementing the method of claim 1.

3. A computer readable medium having instructions stored thereon, wherein said instructions are configured to execute the method of claim 1.

4. The method of claim 1 wherein said formatting step comprises formatting said notice in an HTML format.

5. The method of claim 4 further comprising the step of registering a user of said server prior to said step of receiving said legal notice.

6. The method of claim 5 wherein said registering step comprises obtaining payment information from said user.

7. The method of claim 6 wherein said notice comprises a legal notice.

8. The method of claim 6 wherein said notice comprises a public notice.

9. The method of claim 6 further comprising the step of charging said user for displaying said notice on said server.

10. The method of claim 7 wherein said charging step comprises charging a fee for the period of time that said notice is displayed.

11. The method of claim 1 0 further comprising the step of creating an archive of said notice after said displaying step.

12. The method of claim 1 further comprising the step of creating an archive of said notice after said displaying step.

13. A system for displaying a notice to a viewer via a digital network, said system comprising:
a database configured to store said notice;
an interface to said digital network; and
a server application configured to provide documents to said view via said interface, wherein said server application is configured to retrieve said notice from said database and to provide said notice to said user via said interface in response to requests for said notice received from said user via said interface.

14. The system of claim 13 wherein said notice is a legal notice.

15. The system of claim 14 wherein said notice is a public notice.

16. The system of claim 14 wherein said server application further comprises a billing module configured to receive payment information from a user.

17. The system of claim 14 wherein said database comprises an archive for said notice.

18. The system of claim 16 wherein said database comprises an archive for said notice.
